(19) United States
(12) Patent Application Publication
(10) Pub. No.: US 2015/0129613 A1
(43) Pub. Date: May 14, 2015

(54) Flavorant Dispensing Device For A Beverage Container

(71) Applicant: Hung K. Vuong, Murrieta, CA (US)

(72) Inventor: Hung K. Vuong, Murrieta, CA (US)

(21) Appl. No.: 14/080,394

(22) Filed: Nov. 14, 2013

(51) Int. Cl. B65D 21/02; A23L 2/56

(52) U.S. Cl. CPC B65D 21/02; A23L 2/56
USPC 222/129

(57) ABSTRACT

Improvements in a flavorant dispensing device for a beverage container. The device includes at least two parts that can be temporally engaged onto a beverage container. A central opening allows a user to consume the beverage and some of the flavorant as they consume the beverage. The flavorant is dispensed through a slot or opening where the lip of the drinker is engaged. The flavorant can be a variety of types including but not limited to granular items like salt or sugar, and can also be syrup or extracts. The flavorant opening is an aperture that can alter the horizontal and or vertical size of the opening. The aperture can be angled or stepped and is adjusted by rotating the second part relative to the first part. The aperture can also be completely closed to prevent accidental dispensing of the flavorant.

### CROSS REFERENCE TO RELATED APPLICATION

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

This invention relates to improvements in an attachment for a beverage container. More particularly, the present flavorant dispensing device for a beverage container is filled with a flavorant and temporally applied to a beverage container that allows a person to drink the beverage through the device where a portion of the flavorant can be consumed while the beverage is being consumed.

2. Description of Related Art Including Information Disclosed Under 37 CFR 1.97 and 1.98

For some drinks, such as but not limited to margaritas the rim of the beverage glass can be treated with salt, sugar or other similar flavorants. The rim treatment is typically created by moistening the rim of the glass and then placing the rim of the glass in the flavorant. In these applications the flavorant is typically in a granulized configuration. Some modern beverage producers provide the beverage pre-mixed in a bottle or can configuration where the application of the flavorant to the bottle or can is difficult or impossible.

A number of patents and or publications have been made to address applying flavorants to a beverage. Exemplary examples of patents and or publication that try to address this/these problem(s) are identified and discussed below.

U.S. Pat. No. 6,527,110 issued on Mar. 4, 2003 to Brett Moscovitz discloses a Device for Storing and Dispensing a Substance by Mating with a Container and Associated Method. This patent provides a connection for a bottle with a dispenser. The dispenser can be opened and poured into the beverage bottle. While it allows for dispensing a substance into a bottle it does not allow a user to consume the beverage through the dispenser.

U.S. Pat. No. 6,935,537 issued on Aug. 30, 2005 to Jose H. Tellez discloses a Salt Dispenser for Beverage Bottle. This patent provides a salt dispenser that is mounted onto the opening of a bottle. The salt within dispenser can flow out of an opening in the dispenser where the salt temporally bonds to the rim of the bottle. This patent does not allow for dispensing a substance into a bottle and it does not allow a user to consume the beverage through the dispenser.

U.S. Pat. No. 7,328,670 issued on Feb. 12, 2008 to Maria Puentes-Barr discloses an Apparatus for Dispensing Pourable Material to an Outer Surface of a Vessel. The vessel is a bottle that fits into the dispenser. The vessel then biases a spring to allow media within the dispenser to pour onto the rim of the bottle. While this patent allows for dispensing a substance into a rim of a bottle it does not allow a user to consume the beverage through the dispenser.

What is needed is a device that is placed onto a beverage container with an open center to allow the beverage to be consumed through the device. The device contains a flavorant with an opening on an outer rim of the device to allow a user to consume both the beverage and the flavorant.

### BRIEF SUMMARY OF THE INVENTION

It is an object of the flavorant dispensing device for a beverage container to have at least two parts. The first part is a base that can be temporally engaged onto a beverage container. The engagement passes into or around the beverage container to create a seal where the fluid within the beverage container can only pass through the center of the dispenser. The second part is a cover that contains the flavorant and mates with the first part to allow the flavorant to dispense through an opening in the second part. The flavorant can be a variety of types including but not limited to granular items like salt or sugar, and can also be syrup or extracts. The flavorant compliment or supplement the beverage that is being consumed.

It is an object of the flavorant dispensing device for a beverage container for the device to dispense the flavorant to lower lip of drinker when device is engaged with lower lip during normal drinking motion. This is provided by an opening that passes through the center of the two parts where the beverage can flow through the dispenser to allow for consumption of the beverage and the flavorant at the same time as they consume the beverage.

It is another object of the flavorant dispensing device for a beverage container to provide dispensing of the flavorant from gravity as the beverage container is rotated thereby allowing the flavorant to be available at the opening of the dispenser. The rotation of the beverage container is essentially the same motion used by a user when they are consuming the beverage.

It is still another object of the flavorant dispensing device for a beverage container to include an adjustable aperture. The aperture allows adjustment of the amount of flavorant that is available at the dispensing port. The aperture can alter the horizontal and or vertical size of the opening. The aperture can be angled or stepped and is adjusted by rotating the second part relative to the first part. The aperture can also be completely closed to prevent dispensing of the flavorant.

Various objects, features, aspects, and advantages of the present invention will become more apparent from the following detailed description of preferred embodiments of the invention, along with the accompanying drawings in which like numerals represent like components.

### BRIEF DESCRIPTION OF THE SEVERAL VIEWS OF THE DRAWING(S)

FIG. 1 shows a perspective view of the flavorant dispensing device for a beverage container.

FIG. 2 shows a top exploded perspective view of flavorant dispensing device for a beverage container.

FIG. 3 shows a bottom exploded perspective view of flavorant dispensing device for a beverage container.

FIG. 4 shows a cross sectional view of the flavorant dispensing device for a beverage container.

### DETAILED DESCRIPTION OF THE INVENTION

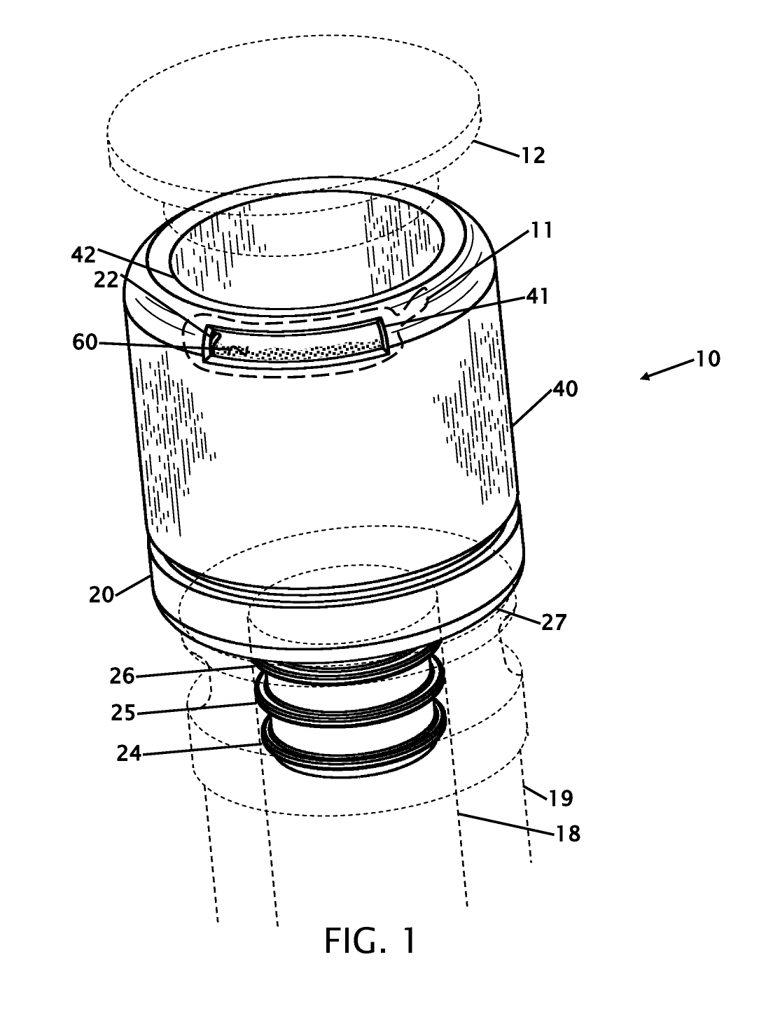

FIG. 1 shows a perspective view of the flavorant dispensing device 10 for a beverage container 19. This view shows the dispensing device 10 installed into the opening of a beverage container 19. The bottom of the dispensing device 10 has a plurality of flanges 24, 25 and 26 that provide a labyrinth type seal with multiple sealing surfaces that prevent fluid from within the bottle 19 from flowing out around the desired flow path of the dispensing device 10. The bottom 27 of the dispensing device 10 seats on the top rim of the beverage container 19. The dispensing device 10 is preferably made from two plastic parts formed from an injection molding operation, but the parts could also be made from rubber or metal and with other processes, such as but not limited to, rotary molding, casting, machining, vulcanizing and 3-D printing.

While the dispensing device 10 is shown on a bottle it should be understood that the same or similar dispensing device 10 could be configured for temporal securing onto a beverage can and/or onto a drinking glass. The dispensing device 10 comprises of two essential interconnecting components of a top housing 40 and a bottom housing 20.

The bottom housing 20 remains essentially secured to the beverage container 19. The bottom housing 20 has a central clearance hole where fluid can essentially freely flow through the passage 18 in the neck of the beverage container 19 through the bottom housing 20. The top housing 40 secures to the bottom housing with a snap or interference arrangement. The top housing 40 also has a central clearance hole 42 where fluid from within the beverage container 19 can flow through the central opening 42. This figure is oriented to show the horizontal slit opening 41 where some flavorant 60 is visible through the horizontal slit opening 41. On the left side of the horizontal slit opening 41 a portion of the metering wall 22 of the lower housing is visible. A sealing tab 11 is shown where the sealing tab 11 provides taper protection to the flavorant with the dispensing device 10.

The metering wall 22 can adjust the flow of the flavorant and/or can be closed to prevent accidental spilling of the flavorant 60 through the horizontal slit opening 41. While a horizontal slit opening 41 is shown and described, one skilled in the art can revise the size and shape of the horizontal slit opening 41 to an oval, vertical slots, etc. . . . An optional cap 12 is shown on top of the dispensing device 10 to enclose the dispensing device 10 to provide some protection of fluid from within the bottle 19 from freely pouring out of the bottle 19 if the bottle 19 is accidentally tipped over.

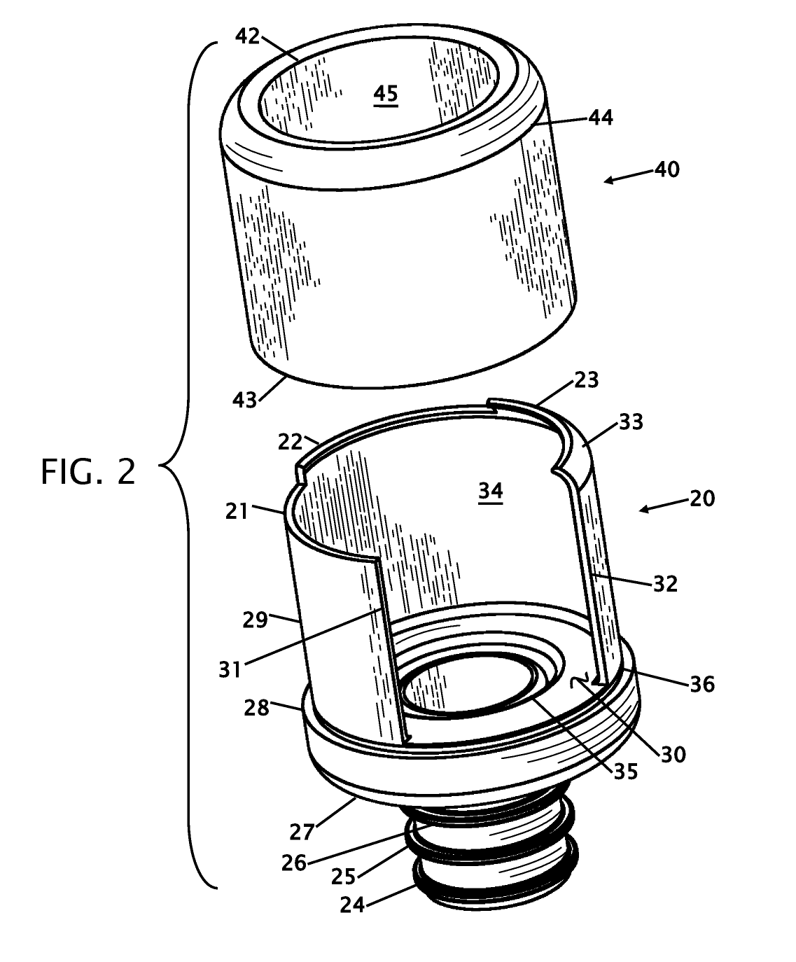

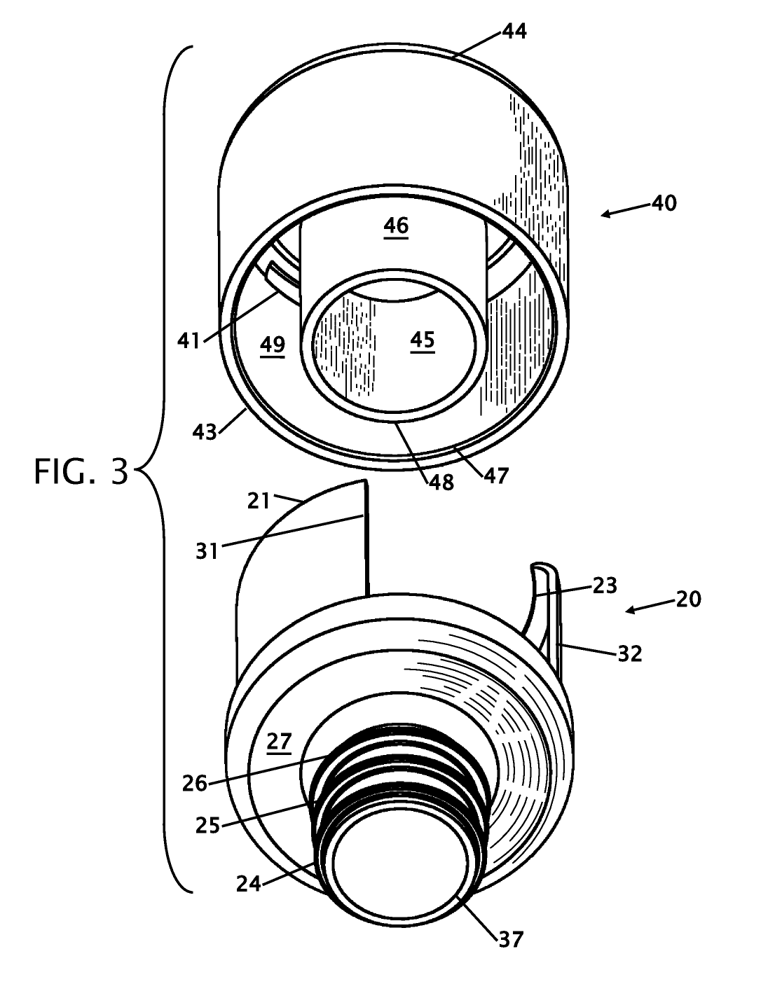

FIG. 2 shows a top exploded perspective view of flavorant dispensing device for a beverage container and FIG. 3 shows a bottom exploded perspective view of flavorant dispensing device for a beverage container. These two exploded views provide view of most or all of the details of the dispensing device 10. With the parts in exploded view the central opening 37 that extends from the bottom housing 20 through the central opening 45 of the top housing 40 is visible. This central opening allows fluid to flow from the beverage container (not shown) out the top central opening 42 of the top housing.

The lower portion of the bottom housing 20 has a plurality of sealing surface 24, 25 and 26 that seal the bottom of the dispensing device with the opening of a bottle. These multiple seals prevent fluid from within the bottle from pouring around the dispensing device and only allow fluid from the beverage container to only flow through the central openings. While the sealing mechanism is shown as three separate sealing ridges as few as one or more than three seals are contemplated with a variety of shapes. It is further contemplated that the dispensing device can be screwed onto a beverage container that uses a threaded cap or lid. The bottom 27 of the lower housing is essentially flat and mates onto the top rim of the beverage container. An inset wall 34 partially extends around from an inside surface 30 on the lower housing 20. The inset wall 34 provides a shutter or seal for the top housing 40.

From FIG. 2 the inset wall 34 is visible with steps 21, 22 and 23 that provide variable sized openings to regulate the amount of flavorant that is available through the flavorant opening slit 41 in the top housing 40. The openings between the edges or ends 31 and 32 of the vertical rib 29 provide unrestricted regulation of flavorant flow, while step 23 provides a complete closure of the flavorant opening. The upper lip 33 of the top step 23 is curved to essentially contour with the interior curvature of the top housing 40. A series of sealing and securing features secure and seal the bottom housing 20 with the top housing 40.

The top housing 40 seats and seals with the bottom housing 20 where the bottom edge 43 of the top housing 40 sits on the lip 28 of the bottom housing 20. A tab 47 in the top housing engages into a slot 36 in the bottom housing 20. To seal the interior of the dispensing device a circular rib 48 in the top housing inserts into a recess 35 in the bottom housing 20. The flavorant is retained within the dispensing device between the interior wall 46 of the top housing and either the interior wall 34 of the bottom housing 40 or the interior wall 49 of the top housing, depending upon the location of the flavorant. The top outer rim 44 of the top housing 40 is curved or rounded to provide comfort to a user as they consume fluid from the beverage through the dispensing device.

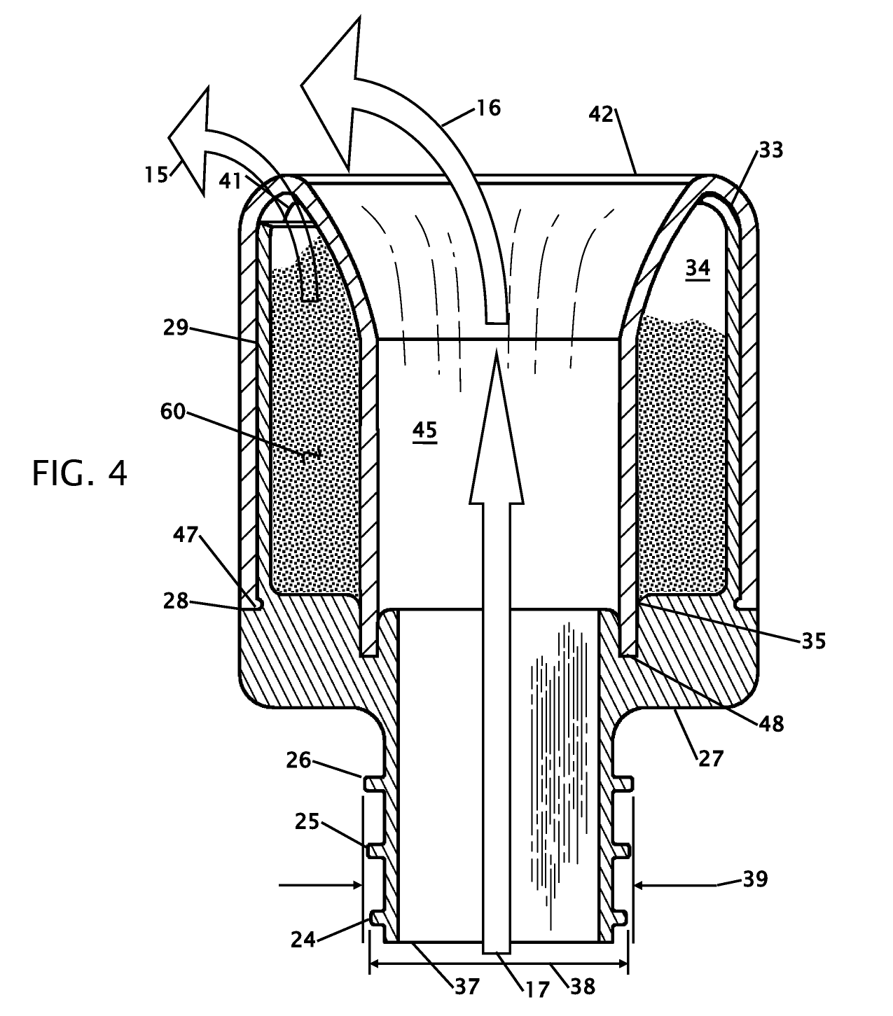

FIG. 4 shows a cross sectional view of the flavorant dispensing device for a beverage container. With the parts in cross section the central opening 37 that extends from the bottom housing 20 through the central opening 45 of the top housing 40 is visible. This central opening allows fluid 16 to flow from the beverage container 17 (not shown) out the top central opening 42 of the top housing. Further some of the flavorant 60 can pass 15 through the dispensing opening 41.

The lower portion of the bottom housing 20 has a plurality of sealing surface 24, 25 and 26 that seal the bottom of the dispensing device with the opening of a bottle. Arrows 38 and 39 show the progressive difference in the diameter of the sealing surfaces 24-26. These multiple seals prevent fluid from within the bottle from pouring around the dispensing device and only allow fluid from the beverage container to only flow through the central openings. The bottom 27 of the lower housing is essentially flat and mates onto the top rim of the beverage container. An inset wall 34 partially extends around from an inside surface on the lower housing 20. The inset wall 34 provides a shutter or seal for the top housing 40.

The upper lip 33 is curved to essentially contour with the interior curvature of the top housing 40. A series of sealing and securing features secure and seal the bottom housing 20 with the top housing 40.

The top housing 40 seats and seals with the bottom housing 20 where the bottom edge of the top housing 40 sits on the lip 28 of the bottom housing 20. A tab 47 in the top housing engages into a slot 36 in the bottom housing 20. To seal the interior of the dispensing device a circular rib 48 in the top housing inserts into a recess 35 in the bottom housing 20. The flavorant 60 is retained within the dispensing device between the interior wall 46 of the top housing and either the interior wall 34 and or 29 of the bottom housing 40 or the interior wall of the top housing 40, depending upon the location of the flavorant within the interior of the dispensing device.

Thus, specific embodiments of a flavorant dispensing device for a beverage container have been disclosed. It should be apparent, however, to those skilled in the art that many more modifications besides those described are possible without departing from the inventive concepts herein. The inventive subject matter, therefore, is not to be restricted except in the spirit of the appended claims.

1. A flavorant dispensing device for a beverage container comprising:
a bottom housing configured to temporally secure to a beverage container;
a top housing configured to secure to said bottom housing,
a cavity between said top housing and said bottom housing to retain a flavorant;
said top and said bottom housing having a central opening whereby fluid from within said beverage container can pass through said central opening, and
a flavorant opening in said top housing whereby said flavorant dispenses from said cavity while fluid from within beverage container passes through said central opening.

2. The flavorant dispensing device for a beverage container according to claim 1 wherein said bottom housing has at least one seal that seals inside a bottle.

3. The flavorant dispensing device for a beverage container according to claim 1 wherein said bottom housing has at least one seal that seals on a threaded neck of a bottle.

4. The flavorant dispensing device for a beverage container according to claim 1 wherein said bottom housing has at least one seal that seals on a can.

5. The flavorant dispensing device for a beverage container according to claim 1 wherein said bottom housing has at least one seal that seals on a glass.

6. The flavorant dispensing device for a beverage container according to claim 1 wherein said flavorant is selected from the group consisting of granular, powder or liquid.

7. The flavorant dispensing device for a beverage container according to claim 6 wherein said flavorant is selected from the group consisting of salt, sugar, citric acid, lemon flavor, lime flavor, nature lemon flavoring, natural lime flavoring or tri-calcium phosphate.

8. The flavorant dispensing device for a beverage container according to claim 1 wherein said opening is a horizontal slot.

9. The flavorant dispensing device for a beverage container according to claim 1 wherein said opening is adjustable to alter a size of said opening.

10. The flavorant dispensing device for a beverage container according to claim 9 wherein said flavorant opening adjustment is by rotation of said top housing relative to said bottom housing.

11. The flavorant dispensing device for a beverage container according to claim 9 wherein said flavorant opening is adjustable to alter a flow rate through said opening.

12. The flavorant dispensing device for a beverage container according to claim 9 wherein said flavorant opening is closeable.

13. The flavorant dispensing device for a beverage container according to claim 9 wherein said adjustment is with steps.

14. The flavorant dispensing device for a beverage container according to claim 1 wherein said flavorant opening is located on the upper rim of said top housing.

15. The flavorant dispensing device for a beverage container according to claim 1 wherein said bottom housing is temporally secured to said top housing.

16. The flavorant dispensing device for a beverage container according to claim 1 wherein said bottom housing is permanently secured to said top housing.

17. The flavorant dispensing device for a beverage container according to claim 1 wherein said top housing and said bottom housing are fabricated from plastic, rubber or metal.

18. The flavorant dispensing device for a beverage container according to claim 1 wherein said flavorant is replaceable.

19. The flavorant dispensing device for a beverage container according to claim 1 that further includes a cover, lid or seal that is temporally securable to said top housing.

20. The flavorant dispensing device for a beverage container according to claim 1 wherein said flavorant opening further includes a removable tamper seal.
